(19) United States
(12) Patent Application Publication
(10) Pub. No.: US 2009/0279120 A1
(43) Pub. Date: Nov. 12, 2009

(54) PRINTING SYSTEM AND METHOD FOR INDICATING THE PRINT STATUS OF AT LEAST ONE IMAGE OF A PRINT SEQUENCE

(75) Inventor: Matthew R. Gerega, Rochester, NY (US)

Correspondence Address: Xerox Corporation (CDFS), 445 Broad Hollow Rd.-Suite 420, Melville, NY, 11747, US

(73) Assignee: Xerox Corporation, Norwalk, CT (US)

(21) Appl. No.: 12/116,531

(22) Filed: May 7, 2008

(51) Int. Cl. G06F 3/12

(52) U.S. Cl. 358/1.15

(57) ABSTRACT

A printing system and method are provided for indicating the print status of a print job, including the print status of individual images of a print sequence having a plurality of images. The printing system and method provide for a printer and a computing device adapted to be connected to each other in order for the computing device to generate and transmit the print sequence having at least one image to the printer for printing thereof. The printing system and method further provide for a display for displaying the at least one image of the print sequence via at least one user interface. The at least one user interface is configured for displaying at least one identifier identifying the print status of the at least one image. The at least one user interface displays the at least one image of the print sequence as a plurality of thumbnails.

### BACKGROUND

1. Technical Field

The present disclosure relates to printing systems and methods, and more particularly, to a printing system and method for indicating the print status of at least one image of a print sequence.

2. Description of Related Art

Conventional printing systems and/or methods include application software that enables a user to print one or more images of a print job from one or more computing devices. Printing systems, and printers associated therewith, may be configured to support both local and network users at the same time. Each of these printer configurations may include printers that are remotely located from a user.

In some instances, a print job may be received by the printer and stored in a buffer or repository accessible by a print engine of the printer. Typically, when a print job is sent to the printer, the application software enables the computing device to provide a visual display that informs a user that the print job has been received by the printer. Knowing when the printer begins printing the print job, or if the printer has successfully completed printing the print job, typically requires a user to physically unload an output device (e.g., stacker) associated with the printer and manually review the print job, and, if needed, reprint any missing sheets and/or remove any sheets that may have been mistakenly printed. This may be a considerable inconvenience to a user, especially in the instance where the printer is a network printer remotely located from the user.

### SUMMARY

The present disclosure provides a printing system capable, inter alia, for indicating the print status of at least one image of a print sequence. The printing system includes a computing device adapted to connect to a printer, such as a xerographic printer. The printer includes a print engine that receives and prints each of a plurality of images in a print sequence or an individual image. The computing device includes one or more processors configured for generating and transmitting the print sequence or an individual image to the printer. In exemplary embodiments, the processor is housed within a computing device. The computing device is operatively connected to one or more user interfaces and is configured for displaying on one or more displays each of the plurality of images of the print sequence by way of the one or more user interfaces.

The printing system includes an image repository that stores each of the plurality of images in the print sequence or individual image transmitted to the printer. The printing system includes one or more application software modules each having a set of programmable instructions configured for execution by the processor, and at least one software module enabling the print engine to print the print sequence, creating a graphical representation of each of the plurality of images of the print sequence, and displaying the graphical representation of each of the plurality of images of the print sequence via the one or more user interfaces such that a user may preview the print sequence.

It is contemplated that each of the plurality of images in the print sequence are displayed as a plurality of thumbnails. Each thumbnail of the plurality of thumbnails corresponds to an image of the plurality of images in the print sequence. A user can scroll back and forward through the displayed thumbnails. Each of the plurality of thumbnails is provided with a status indicator or identifier configured to indicate or identify to a user the print status of the corresponding image of the print sequence.

In an exemplary embodiment of the present disclosure, the printing system includes a printer; computing device in operative communication with the printer for generating and transmitting a print sequence having at least one image to the printer for printing thereof; and a display for displaying the at least one image of the print sequence via at least one user interface. The at least one user interface is configured for displaying at least one identifier identifying the print status of the at least one image.

The present disclosure also provides a method for enabling a printing system operator or user to monitor a print job from a printer adapted to be connected to a computing device configured to generate and transmit a print sequence having at least one image to the printer for printing thereof. The method includes displaying the at least one image of the print sequence via at least one user interface on a display; and displaying at least one identifier identifying the print status of the at least one image on the display.

The present disclosure also provides a computer readable medium storing programmable instructions configured for execution by at least one processor for performing a method. The method includes printing a print job including at least one image; creating at least one graphical representation corresponding to the at least one image of the print job; and displaying the at least one graphical representation via a display. The at least one graphical representation indicating a print status of the at least one image of the print job. The computer readable medium can be a CD-ROM, EEPROM, flash memory, hard drive, DVD, etc. and combinations thereof.

### BRIEF DESCRIPTION OF THE DRAWINGS

Various embodiments of the present disclosure will be described herein below with reference to the figures wherein:

FIG. 1 is a system level block diagram of a printing system that supports a graphical preview user interface in accordance with the present disclosure;

FIG. 2 is a module level block diagram of an image repository depicted in FIG. 1;

FIG. 3 is a module level block diagram of a job status tracking module depicted in FIG. 1;

FIG. 4 is a module level block diagram of a print preview module depicted in FIG. 1;

FIG. 5 is a front plan view of an integrated component printing system that supports the interactive graphical preview user interface depicted in FIG. 1;

FIG. 6 is a system level network diagram if a non-integrated component printing system that supports the interactive graphical preview user interface depicted in FIG. 1;

FIG. 7 is an embodiment of one type of user interface that supports the graphical preview user interface configured for use with the printing system depicted in FIG. 1 in accordance with the present disclosure; and

FIG. 8 is a flow chart illustrating a method for monitoring a print job that includes a plurality of images in accordance with the present disclosure.

### DETAILED DESCRIPTION

As used herein, the word “printer” encompasses any apparatus, such as a digital copier, bookmaking machine, facsimile machine, multi-function machine, and so on. which accepts data relating to images to be printed and outputs prints based on the data.

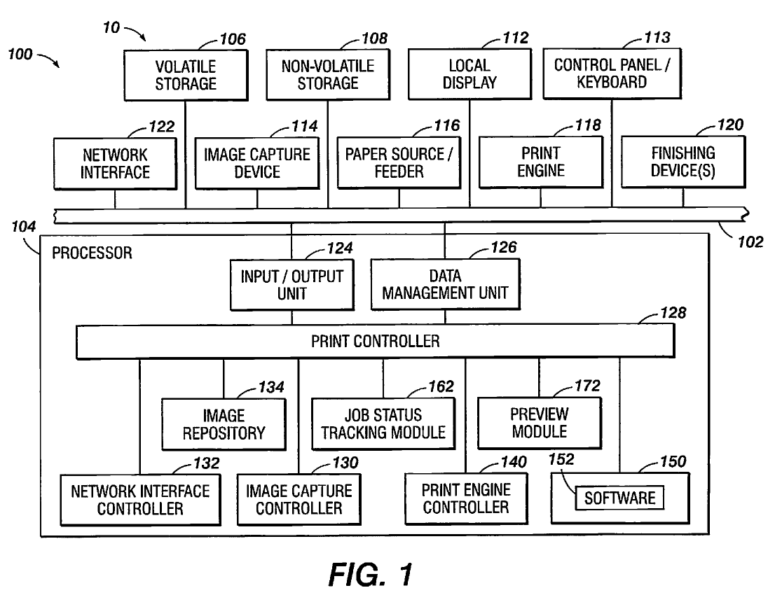

Initially with reference to FIG. 1, a printing system 100 that supports a user interface for a graphical preview of a print job is shown. As described herein, system 100 includes one or more CPUs or processing units 104 (processor 104) and a memory 10. The processor 104 is capable of executing instructions associated with application software modules/controllers and/or system hardware modules. The memory 10 is generic and may comprise RAM 106, ROM 108, CD-ROM (not explicitly shown), or other storage such as hard disk, magnetic tape, and the like.

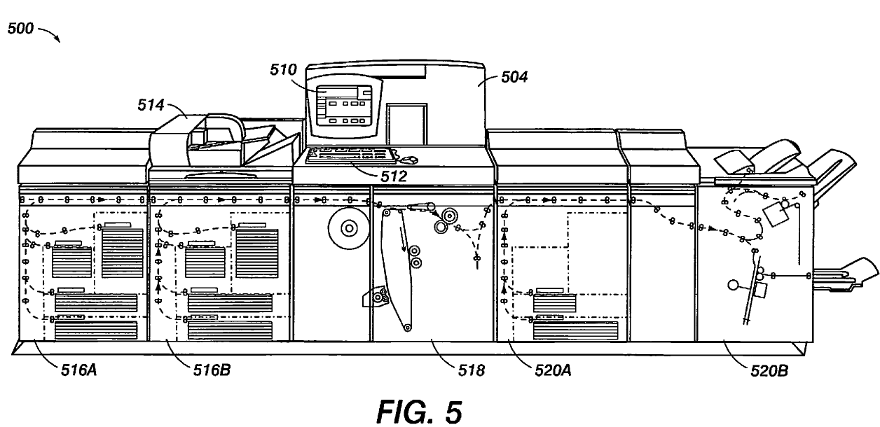

In exemplary embodiments, the processor 104 is housed within a computing device, and the computing device is selected from the group consisting of a multifunction device (such as the XEROX WorkCentre®), a PDA, a mobile telephony device and a personal computer. The computing device can also be incorporated or part of the printing system as, for example, the printing system illustrated by FIG. 5. In this embodiment, the printing system can be the IGEN3® digital printing press system commercially available from the XEROX Corporation.

System 100 includes data bus 102 that allows processor 104 to communicate with, and exchange information with modules/controllers and/or hardware components of system 100 such as: RAM 106, which allows processor 104 to store program instructions in local memory for execution and to store and maintain temporary data necessary for execution of the stored program instructions; ROM 108, which allows processor 104 to access and retrieve larger bodies of data and program instructions for later use/execution by the processor; one or more displays 112, which may support a visual interface with a system operator; one or more control panel/keyboard 113, and/or a cursor control device that allow the processor 104 to retrieve user information and/or instruction and/or feedback; network interface 122 which allows processor 104 to communicate with and exchange information of network connected processing devices, storage devices and/or independent system components; image capture device 114 which scans paper-based documents to be reproduced, thereby allowing printing system 100 to generate and store images of pages within a print job; paper source/feeder 116 which provides the printing system 100 with paper upon which to transfer reproduction copies of scanned/received page images; print engine 118 which transfers visual copies of electronically stored images to paper; one or more finishing devices 120 that receive printed sheets from print engine 118 and process the received sheets, for example, by sorting, collating, folding, stapling, and so on.

Processor 104 includes a plurality of software modules 150 each including a set of programmable instructions configured for execution by the processor 104 for performing the functions disclosed herein. It is contemplated that the functions of the respective software modules may be combined into one or more modules or distributed among a different combination of modules.

Processor 104 may also include internal components that allow the processor 104 to communicate with software and/or hardware components to send and to receive data and instructions over a data bus 102. Such components may include, for example, a print controller 128 capable of communicating with and controlling an input/output unit 124 that manages communication exchanges with the data bus 102; and data management unit 126, which allows the printer to maintain a local set of control parameters, such as counters, pointers, and segments of executable program instructions for execution.

With continued reference to FIG. 1, the plurality of software modules 150 includes an application software module 152 which may include one or more other modules/controllers. Application software module 152 provides for creating a graphical preview of one or more images of a print job. Software module 152 may operate in automatic and/or manual modes of operation. In manual mode, software module 152 may be selectively enabled. In automatic mode, software module 152 may be enabled upon receiving a print request. Automatic mode of operation may also be selectively disabled. Software module 152 includes, or is in operative communication with, print preview module 172, image repository 134 and job status tracking controller 162, the functions of which are described below.

Software module 152 includes programmable instructions capable of being executed by the processor 104 for at least enabling the print engine controller 140 to print a print sequence; creating a user interface for an interactive graphical preview of each of the plurality of images of the print sequence; and displaying the graphical preview of each of the plurality of images of the print sequence via the one or more displays 112 such that a user may preview the print sequence and monitor the status of the print job during printing thereof. Processor 104 may retrieve and load the executable instructions of software module 152 from RAM 106 into ROM 108 for execution and may maintain control parameters in data management unit 126 for use in controlling the simultaneous and/or sequential execution of the program instructions retrieved for execution. With this purpose in mind, software module 152 may be in operable communication with one or more of the above-referenced modules and/or controllers via data bus 102.

For example, software module 152 may be in operable communication with print controller 128. In this instance, software module 152 and/or print controller 128 are configured to control overall operation of the printing system 100 and production of hardcopy output, based on original copy and/or electronically stored images in accordance with operator provided print job control parameters.

Software module 152 is in operable communication with image capture controller 130 which controls the creation of electronic page images from hardcopy images scanned by image capture device 114. The electronic page images are received and stored within image repository 134.

Software module 152 may be in operable communication with network interface controller 132. Interface controller 132 controls the receipt of, for example, operator provided print job control parameters and/or electronic page images receive over a network connection via network interface 122.

Software module 152 is in operable communication with image repository 134. Image repository 134 is configured to store electronic page images captured by image capture controller 130 and/or received by way of network interface 122 for subsequent use thereof.

Software module 152 is in operable communication with job status tracking module 136. Job status tracking module 136 is configured to monitor the status of a pending print job, for example, by recording the identity of one or more images submitted from the image repository 134 to print engine 118, and monitoring the completion of each of the one or more images.

Software module 152 is in operable communication with print engine controller 140 which controls the print engine 118 to execute print jobs in accordance with operator provided print job image sources and/or control parameters, e.g., number of copies, stock/paper selection, enlargement, reduction, and so on.

In operation, each of the above-described modules/controllers in operative communication with software module 152 and executed by processor 104 may maintain a workflow state machine, and/or control parameters that allow the module to perform its assigned task. For instance, software module 152 may include at least a set of master control parameters that allows it to initiate the performance of specific actions by another module and/or controller under the direction of the processor 104. Here, each module/controller executing an assigned task may provide software module 152 with status updates, for example, indicating the completion of a task (e.g., printing), indicating a fault that has occurred during execution of the assigned task (e.g., paper jam), indicating the number of pages processed, and so on, thereby allowing software module 152 to orchestrate activities performed by the respective modules/controllers in series and/or in parallel to expedite the smooth and efficient execution of a print job (and to inform the user of the status of the print job and any printer malfunctions (e.g., paper jam) or conditions (e.g., printer out of paper)).

For example, assuming that a print job relates to producing and finishing copies based on a document placed in image capture device 114, software module 152 may control operation of designated portions of RAM 106 and/or ROM 108 to store images in a preconfigured catalog/file format, and may provide print controller 128 with status updates, e.g., number of pages stored in association with a print job, such that print controller 128 may coordinate execution of other modules/controllers that may be called on to support the print job.

During the printing process, print engine controller 140 provides software module 152 and/or print controller 128 with status updates, e.g., number of pages printed, last page image retrieved from image repository 134, the last page that completed printing, fault/type of fault detected, and so on, that allow software module 152 and/or print controller 128 to coordinate execution of other modules/controllers that may be called on to support the print job. If finishing services have been requested by the user, print controller 128 may initiate a finishing device controller to process the printed pages in accordance with operator provided job finishing parameters (e.g., binding, stapling, etc.). During the finishing process, print controller 128 is provided with high level status updates, e.g., number of pages processed, fault/type of fault detected, and so on.

Software module 152 may store information on the status of the print job. This information may be received directly from one or more respective modules/controllers, e.g., image capture controller 130, print engine controller 140, print controller 128, and so on. Job status information may include, but is not limited to, a list identifying each of the one or more images submitted to print engine 118 by print engine controller 140, including an identifier of the last page image submitted to print engine 118.

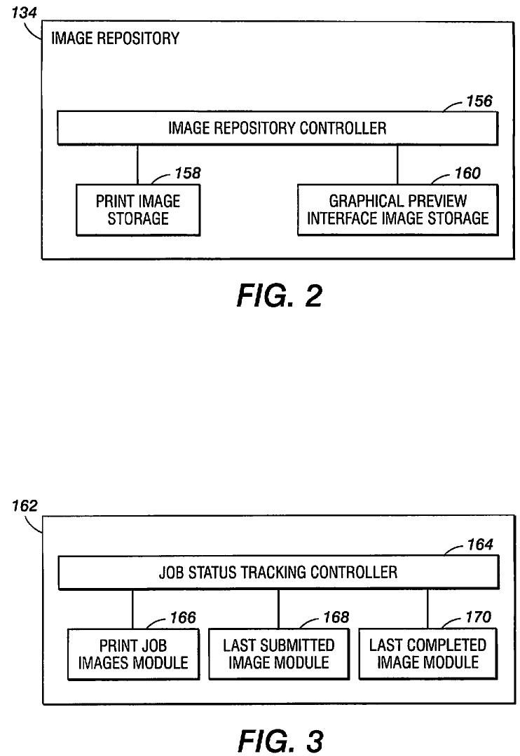

With reference to FIG. 2, an exemplary image repository 134 is shown in block diagram format. Image repository 134 includes an image repository controller 156, print image storage 158 and/or graphical preview interface image storage 160. Image repository 134 receives and stores one or more print job images that are generated, for example, by image capture device 114 under the control of image capture controller 130. Image repository 134 may also receive and store print job images that are received from an external print image source received in association with a remotely initiated print job, for example, over network interface 122 under control of the network interface controller 132. Image repository 134 sends the one or more print job images to the one or more displays 112, such that a user may preview the one or more print job images.

In an exemplary embodiment, image repository 134 is instructed by print controller 128, by way of communication between print controller 128 and image repository controller 156, to receive one or more print images from an identified source, e.g., network interface 122 or image capture device 114, in association with an identified print job. In response, image repository controller 156 may store information related to a print job and begin storing the received one or more print images in print image storage 158 and sending the received one or more print images to the one or more displays 112.

Prior to sending the one or more print images to the one or more displays 112, image repository controller 156 may generate a lower resolution version of each stored print image. In embodiments, the lower resolution versions of each stored printed image may be displayed as thumbnails on the one or more displays 112. The lower resolution images may be stored by image repository controller 156 in graphical preview interface image storage 160. Here, the lower resolution images may be accessible or communicated to one of the previously described modules (e.g., print preview module 172) for possible future use.

FIG. 3 depicts in block diagram format an exemplary controller 162 of software module 152. Controller 162 includes a job status tracking controller 164 and print job images module 166. Controller 162 also includes a last submitted image module 168 and/or last completed image module 170. Operationally, job status tracking controller 164 may communicate with, for example, print controller 128, image repository 134, and/or print engine controller 140 to track the operational status of a pending print job. For example, identifiers for print job images stored in print job images module 166 may be stored in a print job print sequence order based on the order that respective images are received by image repository 134.

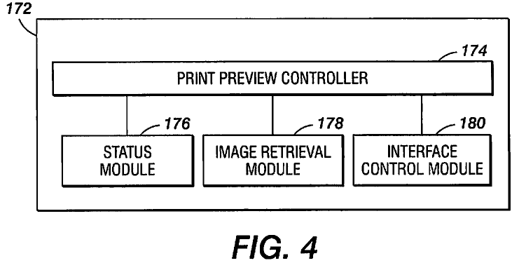

FIG. 4 depicts in block diagram format an exemplary print preview module 172. Print preview module 172 includes a print preview controller 174, a status module 176, an image retrieval module 178, and an interface control module 180. A function of print preview module 172 is to support presentation of a graphical preview user interface which depicts page images to a user corresponding to images being printed.

In operation, print preview module 172 may be invoked by print controller 128, following a restart of processor 104, or in response to detection by software module 152 or print controller 128 of a print request. Upon being invoked, print preview controller 174 may communicate, via status module 176, with image repository controller 156 and/or image retrieval module 178 to obtain page images associated with the print job.

For example, status module 176 communicates with image repository controller 156 to obtain, for example, a listing of page images submitted to print engine 118. Such information may be obtained by image repository controller 156, from print job images module 166, or any other suitable module, and collected and stored by status module 176.

In an exemplary embodiment, status module 176 may also communicate with job status tracking controller 164 to obtain identifiers for the last image submitted to print engine 118 and/or an identifier for the last page image completed by print engine 118.

Once print images have been obtained, print preview controller 174 may invoke image retrieval module 178 to obtain the identified images from image repository 134. For example, image retrieval module 178 may request, by way of communication with image repository controller 156, either copies of the actual print images stored in print image storage 158, or reduced resolution copies of the one or more print images stored in graphical preview interface image storage 160.

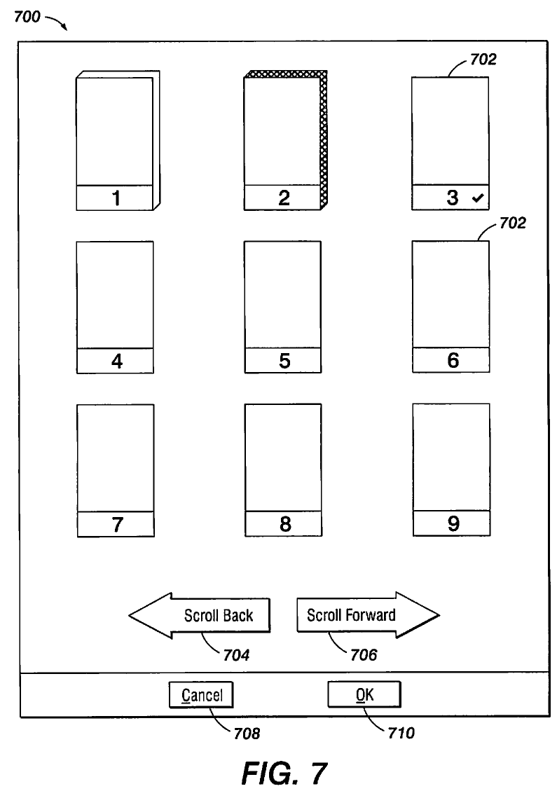

Once the requested status information and images have been retrieved, print preview controller 174 may invoke interface control module 180 to present the printing system operator with an interactive graphical job preview user interface, for example, as described below with respect to FIG. 7. An exemplary interactive graphical print preview user interface may present the printing system operator with a display that includes one or more print images corresponding to the print job.

As described above, the print images may be lower resolution versions of each stored print image, wherein the lower resolution print images may be communicated to one or more displays 112 and presented to the printing system operator as a plurality of thumbnails each corresponding to each of the lower resolution print images in the print job (FIG. 7). As each of the print images is printed, each of the plurality of thumbnails will indicate to the printing system operator that the print image has been printed.

For example, lower resolution print images may include a visual indicator, such as, for example, a checked box or a highlighted border, to indicate that they have been printed (see FIG. 7). The interface may also allow the printing system operator to scroll forward and/or backward through page images presented. The printing system operator may scroll forward and backward through the set of images presented by way of the interactive graphical print preview user interface, or other suitable means, e.g., mouse or keyboard, until the page image displayed as the last page printed corresponds with the last page observed by the printing system operator to have successfully printed.

FIG. 5 is a front plan view of an integrated-component printing system that supports an interactive graphical preview user interface for use in monitoring and/or previewing a print job in accordance with the present disclosure. Printing system 500 may be called an integrated-component printing system because the respective components are included within modular units that may be electrically and mechanically connected into a common physical unit. Suitable commercially available printing systems are manufactured and sold under the trademark WorkCentre™ by the XEROX Corporation.

Printing system 500 includes: a local processing unit 504 that may contain a processor and related circuitry necessary to execute firmware- and/or software-based executable programs for monitoring and controlling operation of printing system 500; a display 510 that supports a visual interface between processing unit 504 and a printing system operator; a control panel/keyboard 512 and/or a cursor control device that allows processing unit 504 to receive user instructions and/or information and/or feedback; an image capture device 514 that scans paper-based documents to be reproduced, thereby allowing printing system 500 to generate and store electronic images of pages within a print job; one or more paper sources/feeders 516 that may provide the printing system with sources of various stock upon which to transfer reproduction copies of scanned/received page images; a print engine 518 configured to transfer visual copies of electronically stored images to paper; and one or more finishing devices 520 that receive printed sheets from print engine 518 and process the received sheets, for example, by sorting, collating, folding, stapling, etc.

Printing system 500 may also include a network interface that allows printing system 500 to execute print jobs based on electronic page images received over a network. Further, local processing unit 504 of printing system 500 may be configured with the firmware/software modules, described above with respect to FIG. 1, that support presentation of a graphical print preview interface with a printing system operator via a display 510 and control panel/keyboard 512.

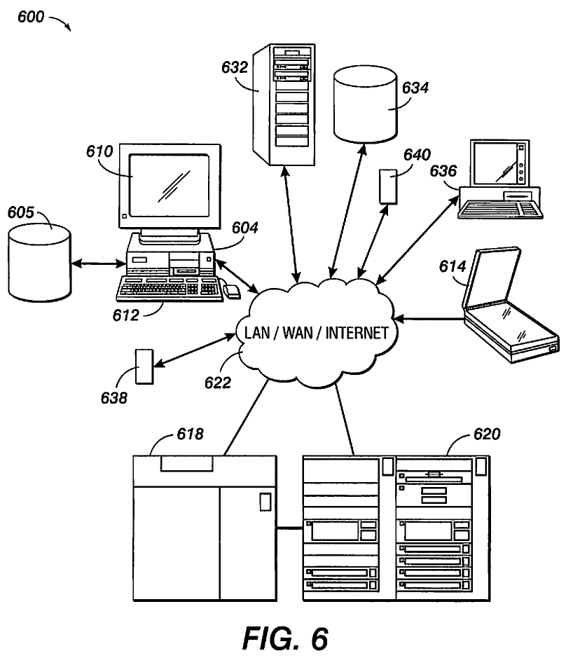

FIG. 6 is a system level network diagram of a non-integrated component printing system 600 that supports an interactive graphical job recovery user interface for use in monitoring and/or previewing a print job in accordance with the present disclosure. Printing system 600 may be called a non-integrated component printing system because the one or more components may be physically separate from the other components forming the printing system.

As shown, printing system 600 includes a network 622 that may include one or more of a local area network (LAN) segment, a wide area network (WAN) segment and/or an Internet segment to provide connectivity between the respect components of the printing system 600. For example, as shown in FIG. 6, components forming printing system 600 may be interconnected by network 622. For example, one component connected via network 622 to form printing system 600 may be processing unit 604 that includes: processor unit 604 and related circuitry necessary to execute firmware- and/or software-based executable programs for monitoring and controlling operation of printing system 600; a display 610 connected to processing unit 604 that may support a visual interface between processing unit 604 and printing system operator; a control panel/keyboard 612; and a local storage device 605 that may be used to store page images prior to transmission of the pages images across network 622 to print engine 618. Other component connected via network 622 to form printing system 600 includes networked removable storage media device 632, data storage device 634, computer workstation 636, PDA 638, mobile phone 640, scanner 614, and print engine 618 with one or more finishing devices 620.

Although many of the components are connected to each other only by network 622, printing system 600 may operate in very much the same manner as that described above with respect to printing system 500.

In printing system 600, however, print job page images may originate from any computing device connected to the network. For example, page images originating from any of network connected removable storage media device 632, network connected data storage device 634, computer workstation 636 and network connected scanner 614 may be transferred to processing unit 604 for storage within image repository 134 for subsequent processing as a print job, and may be submitted by processing unit 604 to print engine 618 and one or more finishing devices 620, resulting in a printed product. So long as a local printing system operator is able to review the hardcopy pages produced by print engine 618 and one or more finishing devices 620 and has access to processing unit 604, the above-described interactive graphical print preview user interface may be operated in the same manner as described above with respect to FIGS. 1-5 in accordance with the present disclosure.

FIG. 7 is a screen capture of a display supported by an interactive graphical print preview user interface in accordance with the present disclosure. As shown in FIG. 7, graphical print preview user interface 700 includes one or more graphical representations 702, a scroll back button 704, a scroll forward button 706, a CANCEL button 708, and an OK button 710.

As described above with respect to FIGS. 1-4, during a print job, application software module 152 may be invoked, either automatically, or by print controller 128. Print preview module 172 retrieves page images associated with current print job from image repository 134 based on status information maintained by controller 162. The status information may include a set of page identifiers for page images within the print job, an identifier of the last page image sent to the print engine 118 for printing, and an identifier for the last page indicated as having been printed.

Once the status information, e.g., page image identifiers, etc., and related page images have been retrieved, print preview module 172 may present on a display 112 of printing system 100, e.g., via print preview controller 174 and/or interface control module 180, an interactive graphical print preview user interface 700, as shown in FIG. 7. For each printed page a corresponding graphical representation of that page is reproduced and displayed on the display 112 as described above.

It is contemplated that images corresponding to successfully printed pages are displayed on display 112. It is further contemplated that images corresponding to all printed pages are displayed on display 112, but the pages that are not printed successfully (e.g., pages printed off center, too light or too dark, etc.) are identified by an identifier, such as a X or a diagonal line across the image.

Once all pages of the print job have printed, an operator may retrieve the print job from the stacker and review for accuracy. If, after review of the print job, any of pages need to be reprinted, the printing system operator may scroll backward or forward, by selecting the appropriate scroll button, 704 and 706, respectively, through the set of images presented via the interactive graphical print preview user interface, to the page(s) that needs to be reprinted. The operator can then click on that image(s) and that image will be transmitted to the print engine 118 for reprinting. It is contemplated that for a touch-screen display, the operator can touch the thumbnail that he desires to reprint. Once the printing system operator determines that the entire print job has successfully printed, the printing system operator may select the OK button 710 and/or CANCEL button 708, and the printing system will resume normal operation.

From the foregoing and with reference to the various figure drawings, those skilled in the art will appreciate that certain modifications can also be made to the present disclosure without departing from the scope of the same. For example, software module 152 may be in operable communication with job recovery module (not explicitly shown) that monitors the status of the printing system 100, for example, whether a fault or a restart has occurred, and initiates an interactive graphical job recovery user interface with images retrieved from image repository 134 based on information obtained from controller 162. For a more detailed description of the operative features of an exemplary job recovery module, reference is made to commonly owned U.S. patent application Ser. No. 11/961,169 filed on Dec. 20, 2007 and titled USER INTERFACE FOR INTERACTIVE GRAPHICAL JOB RECOVERY; the contents of which are incorporated herein by reference.

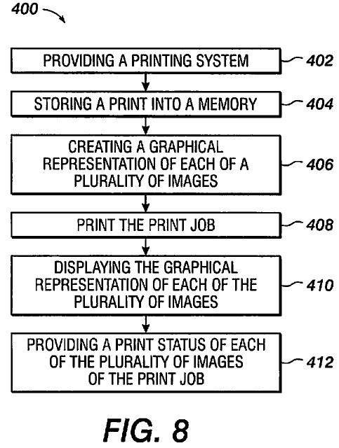

With reference to FIG. 8 there is shown a flow chart 400 illustrating a method for monitoring a print job that includes displaying a plurality of images corresponding to pages printed. At step 402, a printing system is provided such as printing system 100. The printing system includes a computing device in operative communication with a printer. The computing device includes one or more processors configured for communicating the print sequence to the printer. The computing device is operatively connected to one or more displays and is configured for displaying each of the plurality of images of the print sequence via the at least one display. The computing device includes an image repository that stores each of the plurality of images in the print sequence sent to the printer and at least one application software module having a set of programmable instructions configured for execution by the processor for: enabling said print engine to print the print sequence; creating a graphical representation of each of the plurality of images of the print sequence; and displaying the graphical representation of each of the plurality of images of the print sequence via the one or more displays. At step 404, the print job is stored into memory of an image repository. At step 406, a graphical representation of each of the plurality of images of the print sequence is created. At step 408, the print job is printed. At step 410, the graphical representation of each of the plurality of images of the print sequence is displayed. And at step 412, the print status of each of the plurality of images of the print job is provided to a user.

The above steps are just one sequence of steps in accordance with the present disclosure. Those skilled in the art will appreciate that steps 402-412 may be carried out in a plethora of different, yet suitable, sequences, including performing one or more steps simultaneously, such as steps 408 and 410.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A printing system comprising:
a computing device adapted to connect to a printer for generating and transmitting a print sequence having at least one image to the printer for printing thereof; and
a display in operative communication with the computing device for displaying the at least one image of the print sequence via at least one user interface, the at least one user interface is configured for displaying at least one identifier identifying the print status of the at least one image.

2. The system according to claim 1, wherein the at least one image includes a plurality of images and the at least one user interface includes controls for scrolling through the plurality of images and enables the selection of at least one image to be reprinted.

3. The system according to claim 1, wherein the at least image includes a plurality of images and the at least one user interface displays the plurality of images of the print sequence as a plurality of thumbnails.

4. The system according to claim 3, wherein the at least one identifier indicating an image of the print sequence has printed is a highlighted border of a thumbnail corresponding to the printed image.

5. The system according to claim 3, wherein the at least one identifier indicating an image of the print sequence has printed is a checked box in proximity to a thumbnail corresponding to the printed image.

6. The system according to claim 1, further comprising an image repository for storing the at least one image of the print sequence.

7. The system according to claim 1, wherein the computing device is selected from the group consisting of a multifunction device, a PDA, a personal computer, and a mobile telephony device.

8. The system according to claim 1, wherein the computing device includes at least one processor storing a plurality of modules each having programmable instructions configured for execution by the at least one processor for at least generating and displaying said at least one user interface.

9. The system according to claim 1, wherein the display is a touch-screen display.

10. A method for enabling a printing system operator or user to monitor a print job from a printer adapted to be connected to a computing device configured to generate and transmit a print sequence having at least one image to the printer for printing thereof, the method comprising:
displaying the at least one image of the print sequence via at least one user interface on a display; and
displaying at least one identifier identifying the print status of the at least one image on the display.

11. The method according to claim 10, wherein the at least one image includes a plurality of images and the at least one user interface includes controls for scrolling through the plurality of images and enables the selection of at least one image to be reprinted.

12. The method according to claim 10, wherein the at least one image includes a plurality of images and the at least one user interface displays the plurality of images of the print sequence as a plurality of thumbnails.

13. The method according to claim 12, wherein the at least one identifier indicating an image of the print sequence has printed is a highlighted border of a thumbnail corresponding to the printed image.

14. The method according to claim 12, wherein the at least one identifier indicating an image of the print sequence has printed is a checked box in proximity to a thumbnail corresponding to the printed image.

15. The method according to claim 10, further comprising storing the at least one image of the print sequence in an image repository.

16. The method according to claim 10, wherein the computing device is selected from the group consisting of a multifunction device, a PDA, a personal computer, and a mobile telephony device.

17. The method according to claim 10, wherein the computing device includes at least one processor storing a plurality of modules each having programmable instructions configured for execution by the at least one processor for at least generating and displaying said at least one user interface.

18. The method according to claim 10, wherein the display is a touch-screen display.

19. A computer-readable medium storing programmable instructions configured for execution by at least one processor for performing a method comprising:
printing a print job including at least one image;
creating at least one graphical representation corresponding to the at least one image of the print job; and
displaying the at least one graphical representation via a display, said at least one graphical representation indicating a print status of the at least one image of the print job.

20. The computer readable medium according to claim 19, wherein the at least one graphical representation is a thumbnail.
